(19) United States
(12) Patent Application Publication
(10) Pub. No.: US 2014/0218315 A1
(43) Pub. Date: Aug. 7, 2014

(54) GESTURE INPUT DISTINGUISHING METHOD AND APPARATUS IN TOUCH INPUT DEVICE

(71) Applicant: ELECTRONICS AND TELECOMMUNICATIONS RESEARCH INSTITUTE, Daejeon (KR)

(72) Inventor: Hyuk JEONG, Daejeon (KR)

(21) Appl. No.: 14/083,901

(22) Filed: Nov. 19, 2013

(30) Foreign Application Priority Data
Feb. 7, 2013 (KR) 10-2013-0013899

(51) Int. Cl. G06F 3/041

(52) U.S. Cl. CPC G06F 3/0416
USPC 345/173

(57) ABSTRACT

A gesture input distinguishing method and apparatus are provided. The gesture input distinguishing method and apparatus provide a method of distinguishably inputting a gesture related to a touch and drag on a touch screen according to patterns.

### CROSS-REFERENCE TO RELATED APPLICATION

This application claims the benefit of Korean Patent Application No. 10-2013-0013899, filed on Feb. 7, 2013, in the Korean Intellectual Property Office, the disclosure of which is incorporated herein by reference.

### BACKGROUND

1. Field of the Invention

The present invention relates to a gesture input distinguishing method and apparatus for distinguishing a general pointing function and a gesture function from each other using a pointing device, when executing a gesture command.

2. Description of the Related Art

To control content on a screen during use of a terminal in a user interface (UI) environment, a touch needs to be generated using a pointing device such as a mouse or a finger. Such a method enables selection of a particular menu through a click or a touch, and a page turning function through dragging or flicking.

However, when an application program is controlled using only a mouse pointer and one or two fingers, only one spot on the screen may be selected or a movement may be made in only a linear direction while the spot selection is maintained.

Accordingly, there is a desire for a method for executing various commands by recognizing a movement maintaining a touch since the touch has been made on the screen, and for defining various touch gestures by distinguishing a general mouse click, a single finger click, and a multi touch using a plurality of fingers.

### SUMMARY

An aspect of the present invention provides a gesture input distinguishing method and apparatus enabling a gesture related to a touch and drag on a touch screen to be distinguishably input according to shapes.

Another aspect of the present invention provides a gesture input distinguishing method and apparatus which identifies a position path formed from a first spot in which a touch is generated to a second spot in which the touch ends on a screen of a terminal providing a graphic user interface (GUI), analyzes a pattern according to the position path, and executes a command corresponding to the pattern.

Still another aspect of the present invention provides a gesture input distinguishing method and apparatus enabling execution of various commands by recognizing a multi touch made through gestures of a plurality of fingers.

According to an aspect of the present invention, there is provided a gesture input distinguishing method including counting a number of touches generated on a screen of a terminal that provides a graphic user interface (GUI), converting the terminal into a gesture input mode when the number of touches is reduced to one, and executing a command corresponding to the reduced number of touches according to conversion into the gesture input mode.

According to another aspect of the present invention, there is provided a gesture input distinguishing apparatus including a counter to count a number of touches generated on a screen of a terminal that provides a GUI, a mode converter to convert the terminal into a gesture input mode when the number of touches is reduced to one, and a command executor to execute a command corresponding to the reduced number of touches according to conversion into the gesture input mode.

### EFFECT

According to embodiments of the present invention, a method of executing a mouse gesture function made by a touch and drag distinguishably from other existing functions in a multi touch input device may be provided.

According to embodiments of the present invention, a particular command may be conveniently executed using a mouse gesture without the necessity of exposing a menu or icon on a screen in a state in which a user is focusing on content.

According to embodiments of the present invention, a user, such as a blind person, who is difficult to select an icon disposed on a particular position on a touch screen may conveniently use an information communication apparatus equipped with a touch input device by making a simple gesture.

Also, according to embodiments of the present invention, since a gesture according to a drag after a finger touch on a screen may be input in various patterns, a function corresponding to the gesture may be executed with ease.

Additionally, according to embodiments of the present invention, since a multi touch made by a plurality of fingers is recognized, the user may control content without having to expose a menu.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a detailed configuration of a gesture input distinguishing apparatus according to an embodiment of the present invention;

FIG. 2 is a diagram illustrating a configuration of a command executor according to an embodiment of the present invention;

FIG. 3 is a diagram illustrating identification of a position path according to an embodiment of the present invention;

FIG. 4 is a diagram illustrating an example of pattern analysis according to an embodiment of the present invention;

FIG. 5 is a block diagram illustrating an example of pattern analysis according to another embodiment of the present invention; and

FIG. 6 is a flowchart illustrating a gesture input distinguishing method in a according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. However, the scope of the present invention is not limited to the exemplary embodiments.

The embodiments are related to a method for distinguishing a general pointing function and a gesture function from each other when realizing a gesture command using a pointing device.

To select a particular menu in a graphic user interface (GUI) environment during use of a computer, a pointing device such as a mouse is necessary. The pointing device may enable a command corresponding to an icon or a menu designated by a pointer to be executed through a button click.

Depending on cases, the computer may be controlled by using the pointing device in a different manner, an example of which is a mouse gesture.

The mouse gesture uses a movement of a pointer rather than an accurate position of the pointer. For example, when the mouse pointer is moved in a particular way with a right mouse button pressed, mouse gesture software of the system recognizes a movement of the pointer and executes a predetermined command, such as a previous page view.

The mouse gesture may provide a user with convenience of executing a particular command without exposing a menu or an icon while the user is focusing on content. However, in order to distinguish a pointer position manipulation for general mouse functions such as selection, drag, and execution, from a pointer position manipulation for the gesture command, a method for informing the system that the gesture command is currently executed is necessary.

In a mouse including two buttons, a right button may be used to distinguish the mouse gesture. For example, in the two button mouse, the mouse gesture may be set as to follows. When the mouse is moved with a left mouse button pressed, a range of selecting an object such as an icon may be controlled. On the other hand, when the mouse is moved with the right mouse button pressed and then the right mouse button is released, a predetermined command may be executed.

To implement the mouse gesture in an information communication terminal equipped with a touch screen, such as a smart phone, a smart pad, and the like, a method of distinguishing a conventional touch and drag motion from a gesture input is necessary. That is, when a drag is made after a finger touch is made on a a screen in a smart phone, the screen may be scrolled vertically or laterally or page turning to a previous page or next page may be performed.

Accordingly, the embodiments of the present invention suggest a method for distinguishably inputting basic functions and a gesture function related to the touch and drag in a multi touch input device.

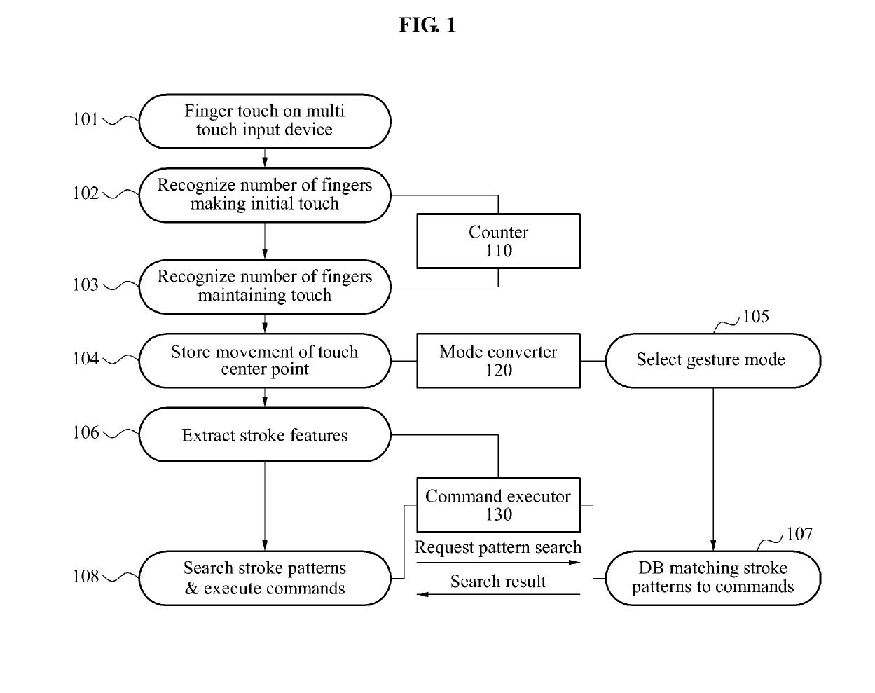

FIG. 1 is a diagram illustrating a detailed configuration of a gesture input distinguishing apparatus according to an embodiment of the present invention.

The gesture input distinguishing apparatus may include a counter 110, a mode converter 120, and a command executer 130.

The counter 110 may count a number of touches generated on a screen of a terminal that provides a GUI. That is, the counter 110 may monitor the reduction state of the number of touches from an initial number.

The mode converter 120 may convert the terminal into a gesture input mode when the counted number of touches is reduced to one. For example, the mode converter 120 may convert the terminal into the gesture input mode when the counted number of touches is reduced from at least two to one within a predetermined time.

The command executor 130 may execute a command corresponding to the reduced number of touches according to the conversion into the gesture input mode. That is, the command executor 130 may distinguish the gesture input mode and accordingly executes a gesture command.

In one embodiment, the command executor 130 may extract a first gesture command from a database (DB) by further considering the counted number of touches.

When the number of touches is maintained to n which is a natural number equal to or greater than two, that is, when the number of touches is not reduced to one, the command executor 130 may execute the command corresponding to the touch and drag without converting the terminal into the gesture input mode.

Hereinafter, the gesture input method according to the embodiment of the present invention will be described in detail with reference to FIG. 1.

First, in operation 101, the user may touch the screen of the multi touch input device by a finger or fingers.

Next, in operation 102, the counter 110 may recognize and store a number of fingers touching the multi touch input device. That is, in operation 102, the counter 110 may recognize the number of fingers that made an initial touch on the screen.

In operation 103, the counter 110 may check whether the number of fingers is reduced to one by the user. For example, in operation 103, the counter 110 may check whether the user touched two fingers on the multi touch input device in the beginning and then separated one finger remaining another one finger. That is, the counter 110 recognizes the number of fingers maintaining the touching state.

In operation 104, the mode converter 120 may store a movement of a touch center point of one finger maintaining the touching state until the user separates the finger from the multi touch input device. That is, in operation 104, the mode converter 120 may extract the movement related to a center point of one maintained touch.

In addition, in operation 105, the mode converter 120 may select a gesture mode for executing different commands with respect to a same stroke according to the number of fingers that made the initial touch. For example, when the number of fingers that made the initial touch is two and three, although a movement of one finger maintaining the touch is an L pattern in both cases, the mode converter 120 may execute a ‘program termination’ function when the number of fingers is two and execute a ‘turn to the next page’ function when the number of fingers is three. That is, different commands may be executed.

In operation 106, the command executor 130 may extract features of the movement of the stored touch center point, that is, the stroke. The features may be various. According to the embodiment, the features may include an initial movement direction in which the stroke is started, a direction of a movement of right before the stroke is ended, and a number of inflection points of an entire stroke.

In addition, the command executor 130 may compare the features extracted in operation 106 with a DB that matches stroke patterns to commands in operation 107, and receive and execute a corresponding command in operation 108. The DB of operation 107, which matches the stroke patterns to the commands, may enable different commands to be executed even with respect to a same stroke pattern according to the gesture mode selected in operation 105.

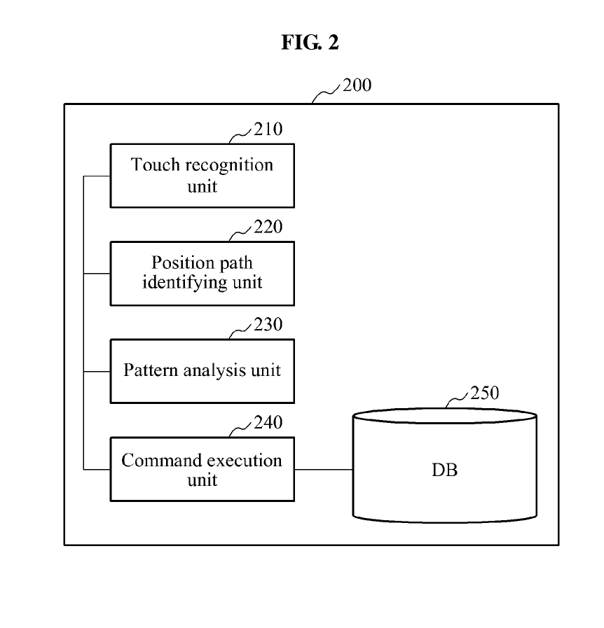

FIG. 2 is a diagram illustrating a configuration of a command executor 200 according to an embodiment of the present invention.

Referring to FIG. 2, the command executor 200 may be included in a terminal in which a touch by a human finger is made on a screen of the terminal. When the human finger or an object touches a particular position of the screen, the terminal may recognize the particular position and perform specific processing by stored software. The command executor 200 may analyze the touch made on the terminal and identify a gesture made by the touch, so that a corresponding command is processed by the terminal.

In an embodiment, the command executor 200 may include a touch recognition unit 210, a position path identifying unit 220, a pattern analysis unit 230, a command execution unit 240, and a DB 250.

The touch touch recognition unit 210 may recognize a first spot in which the touch is generated, on the screen of the terminal. For this, the touch recognition unit 210 may include a sensor for detecting a signal of the first spot that may be generated when the user contacts a finger tip on the screen of the terminal. For example, when a current flows through the screen, the sensor may detect electrons drawn to a contacting position of the finger of the user. The first spot may have a position coordinate on the screen. The touch recognition unit 210 may measure a distance between a reference point on the screen and the first spot with respect to a vertical direction and a horizontal direction using the position coordinate.

The touch recognition unit 210 may support a multi touch by recognizing a plurality of first spots simultaneously. A number of the first spots may be determined by a number of available fingers of the user, a size of the screen, and the like.

For example, the user may contact an index finger and a middle finger on the screen simultaneously, or may contact the index finger first and then contact the middle finger while maintaining the contact of the index finger. In this case, the touch recognition unit 210 may recognize two first spots at time points when touches of the index finger and the middle finger are generated.

When the terminal is a smart phone, the user may hold the terminal by one hand and make a multi touch with maximally five fingers of the other hand. Therefore, the touch recognition unit 210 may recognize at most five first spots.

The position path identifying unit 220 may identify a position path indicating a position change from the first spot to a second spot in which the touch is ended. The first spot and the second spot may be in different positions. When the first spot and the second spot are recognized to be same since the touch is generated and also ended in the first spot, the position path identifying unit 220 may determine that the position path is absent in this case and end the execution.

In the embodiment, when an n-number of the first spots are recognized, where n is a natural number equal to or greater than two, the position path identifying unit 220 may identify an n-number of position paths from each of the n-number of first spots to the second spot. For example, when the user contacts the index finger on a particular position of the screen and moves the index finger and, during this, contacts the middle finger on another position and moves the middle finger, the position path identifying unit 220 may separately identify a position path formed by the index finger that first ended the touch and a position path formed by the middle finger that next ended the touch.

The pattern analysis unit 230 may analyze a pattern of the position path in consideration of a gesture of the user according to shapes. The user may make a gesture by moving a finger tip in contact with the screen in every direction.

The pattern analysis unit 230 may consider at least one of a number of inflection points of the position path and a direction change of the position path. For example, when position paths have the same number of inflection points and the same direction change, the pattern analysis unit 230 may analyze the position paths to have a same pattern. The pattern analysis unit 230 may analyze the patterns including a straight line, a curve, a polygon, a circle, a number, and a character, and the like of the position path. In addition, the pattern analysis unit 230 may classify a plurality of position paths according to the pattern. When the number of inflection points and the direction change are not extracted from the position path, the pattern analysis unit 230 may end the execution.

Furthermore, the pattern analysis unit 230 may set a reference value when analyzing a length of the position path. The reference value may be used to determine validity of the identified position path.

The position path may be in various shapes such as a curve, a straight line, a bent line, and the like on the screen. The pattern analysis unit 230 may analyze the position path by designating the shapes as the pattern. In a case in which the reference value is set to 5 pixels and the length of the position path is less than 5 pixels, the pattern analysis unit 230 may determine the position path to be invalid without considering the pattern. Conversely, when the length of the position path is not less than 5 pixels, the pattern analysis unit 230 may have the command execution unit 240 execute a corresponding command considering the pattern. The command execution unit 240 will be described later.

The pattern analysis unit 230 may have the command execution unit 240 extract a first gesture command when the position path includes the inflection point or shows the direction change. When the inflection point or the direction change is absent, the pattern analysis unit 230 may have the command execution unit 240 extract and execute a second gesture command which is set instead of the first gesture command. The second gesture command may be a gesture for calling a selection function and a page turning function defined with respect to a single touch not the multi touch.

The command execution unit 240 may extract the first gesture command corresponding to the pattern from the DB 250 and execute the first gesture command. The first gesture command may be a method for calling a program control function, for example a program termination function, a turn to the next page function on a web browser, and the like, executed by the terminal.

The DB 250 may store information on the first gesture command. The DB 250 may extract the first gesture command according to a pattern name and a pattern type.

The command executor 200 may manage a list of executable commands and a list of patterns that may be made by fingers of the user, and generate a manual by matching a randomly selected pattern to a command so that the user may execute the command. In addition, the command executor 200 may store relationships between the commands defined by the user and the patterns in the DB 250, thereby executing the command corresponding to a touch gesture set by the user.

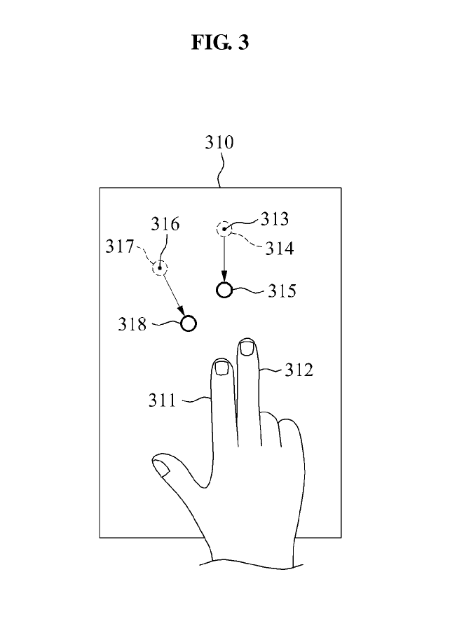

FIG. 3 is a diagram illustrating identification of a position path according to an embodiment of the present invention.

Referring to FIG. 3, the user may make a gesture by moving an index finger 311 and a middle finger 312 which are in a state of touching a display screen 310. The user may touch the display screen 310 with the middle finger 312 and move the middle finger 312 first, and then may touch the display screen 310 with the index finger 311 simultaneously with the middle finger 312 while moving the middle finger 312 downward on the display screen 310. The touch recognition unit 210 may recognize a spot 313 in which the touch is first generated by the middle finger 312 as the first spot, and include a spot 316 in which the touch by the index finger 311 is generated in the first spot.

The touch recognition unit 210 may calculate contacting areas 314 and 317 with respect to the first spots 313 and 316. The first spot 313 of the middle finger 312 may have an area as wide as a portion of the middle finger 312 contacting the display screen 310. The touch recognition unit 210 may calculate the area as the contacting area 314. In addition, the touch recognition unit 210 may calculate an area as wide as a portion of the index finger 311 contacting the display screen 310, as the contacting area 317. By calculating the contacting areas 314 and 317 of the first spots 313 and 316, the touch recognition unit 210 may recognize the touch accurately irrespective of intensity of a touch force or a size of the index finger 311 and the middle finger 312.

When the two first spots 313 and 316 are recognized, the position path identifying unit 220 of FIG. 2 may identify the position path in which the touch of the index finger 311 and the middle finger 312 is maintained and moved. According to a downward movement of the index finger 311 and the middle finger 312, the position path identifying unit 220 may identify two position paths. The user may reduce a gap between the index finger 311 and the middle finger 312 as moving the index finger 311 and the middle finger 312 downward of the display screen 310, by changing movement directions of the index finger 311 and the middle finger 312.

Here, the touch recognition unit 210 recognizes second spots 315 and 318 in which the touches of the index finger 311 and the middle finger 312 are ended at different spots from the first spots 313 and 316. Accordingly, the touch recognition unit 210 may identify a position path formed based on the second spots 315 and 318 recognized by the position path identifying unit 220. In FIG. 3, the touch recognition unit 210 may recognize the spot 315 in which the touch of the middle finger 312 is ended first and the spot 318 in which the touch of the index finger 311 is ended next.

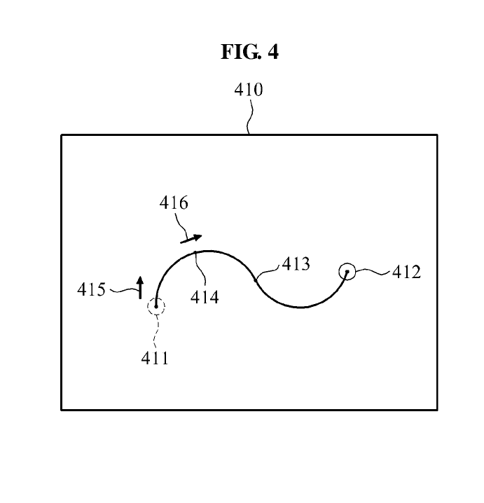

FIG. 4 is a diagram illustrating an example of pattern analysis according to an embodiment of the present invention.

Referring to FIG. 4, the pattern analysis unit 230 may receive an input of data related to a touch area 410 in which the touch gesture of the user is recognized by the touch recognition unit 210 and the position path identifying unit 220.

In the touch area 410, a first spot 411 refers to a spot in which a touch is first generated when the user of the terminal makes the touch gesture with one finger. A second spot 412 refers to a spot in which the touch gesture is ended. The pattern analysis unit 230 may consider position values of spots present on a position path from the first spot 411 and the second spot 412 and relationships between two neighboring spots.

First, the pattern analysis unit 230 may consider a start point direction 415 of a start point of the touch gesture in the first spot 411. The start point direction 415 may be obtained using a position change of a point neighboring the first spot 411. FIG. 4 shows an example of a position path starting from the first spot 411 in the touch area 410 and being in the form of a curve including a convex portion and a concave portion.

The user may start the touch gesture by pressing the first spot 411 with the finger and moving the finger in the start point direction 415 while maintaining the pressing state. Every time the finger moves by a unit recognizable by the command executor 200, a direction of the point may be changed. A difference between the start point direction and a direction 416 with respect to a predetermined point 414 on the position path may be calculated as an angle.

When distinguishing patterns of the curve, the pattern analysis unit 230 may consider an inflection point 413 in the touch area 410. At the inflection point 413, the position path may be changed from a convex shape to a concave shape. The pattern analysis unit 230 may identify a number and position information of the inflection points 413, so that the command execution unit 240 may extract a command related to a pattern having a same number and position of inflection points from the DB 250.

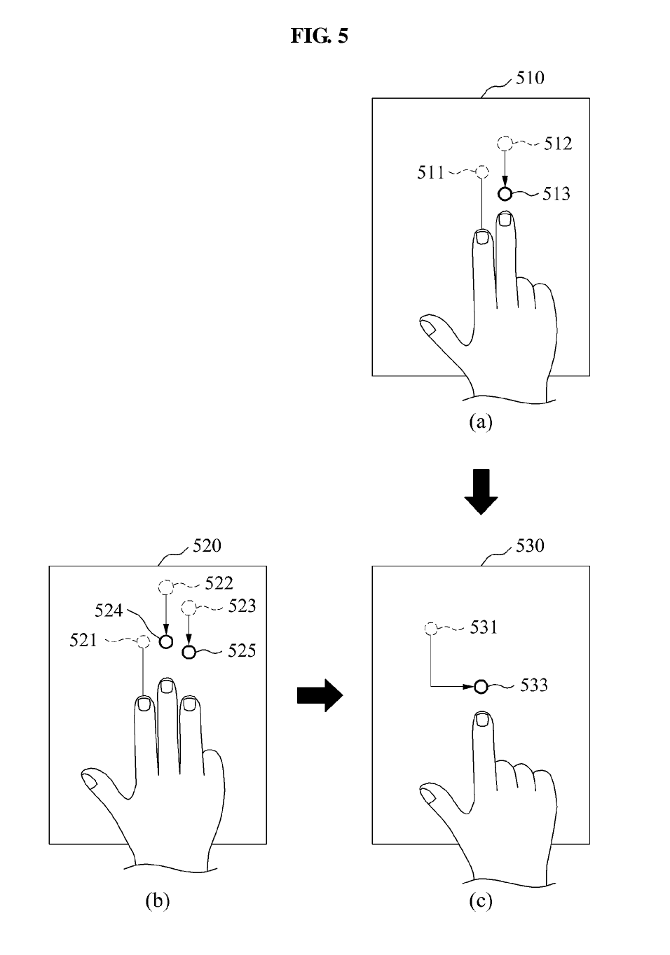

FIG. 5 is a block diagram illustrating an example of pattern analysis according to another embodiment of the present invention.

In FIG. 5(a), when a multi touch is generated on a display screen 510, the position path identifying unit 220 may calculate lengths of the position paths from first spots 511 and 512 in which touches of the multi touch are started to a second spot 513 in which the multi touch is ended.

For example, the position path identifying unit 220 may identify a length of a position path of a middle finger to the second spot 513 in which the touch of the middle finger is ended on the display screen 510, and identify information on spots on a position path of an index finger which has not ended the touch. The position path identifying unit 220 may compare the length of the position path of the middle finger to a reference value to determine whether the length is smaller than the reference value.

In FIG. 5(b), when a multi touch is generated on a display screen 520, the position path identifying unit 220 may calculate lengths of the position paths from first spots 521, 522, and 523 in which touches of the multi touch are started to second spots 524 and 525 in which the touches are ended.

The position path identifying unit 220 may identify lengths of position paths of the middle finger to the second spots 524 and 525 in which touches of the middle finger and a ring finger are ended on the display screen 520, and identify information on spots of a position path of the index finger which has not ended the touch. The position path identifying unit 220 may compare the length of the position paths of the middle finger to the reference value to determine whether the length is smaller than the reference value.

The touch of the index finger, which is not ended in the display screen 510 and 520 of FIGS. 5(a) and 5(b), may be ended in a second spot 533 of a display screen 530 of FIG. 5(c). Here, a first spot 531 of FIG. 5(c) may correspond to the first spot 511 of FIG. 5(a) and the first spot 521 of FIG. 5(b). When the index finger makes a same gesture in the display screens 510 and 520 of FIGS. 5(a) and 5(b), the pattern analysis unit 230 may may recognize the first spot 421 and the second spot 533 of the display screen 530 and analyze an L-shape pattern.

When the pattern analysis unit 230 analyzed the L-shape pattern as shown in FIG. 5(c) with respect to the both multi touches generated in FIG. 5(a) and FIG. 5(b), the pattern analysis unit 230 may distinguish the patterns according to the number of the first spots. For example, the pattern analysis unit 230 may distinguish a multi touch starting from two first spots in FIG. 5(a) and a multi touch starting from three first spots of FIG. 5(b) from each other, so that the command execution unit 240 may execute two different commands.

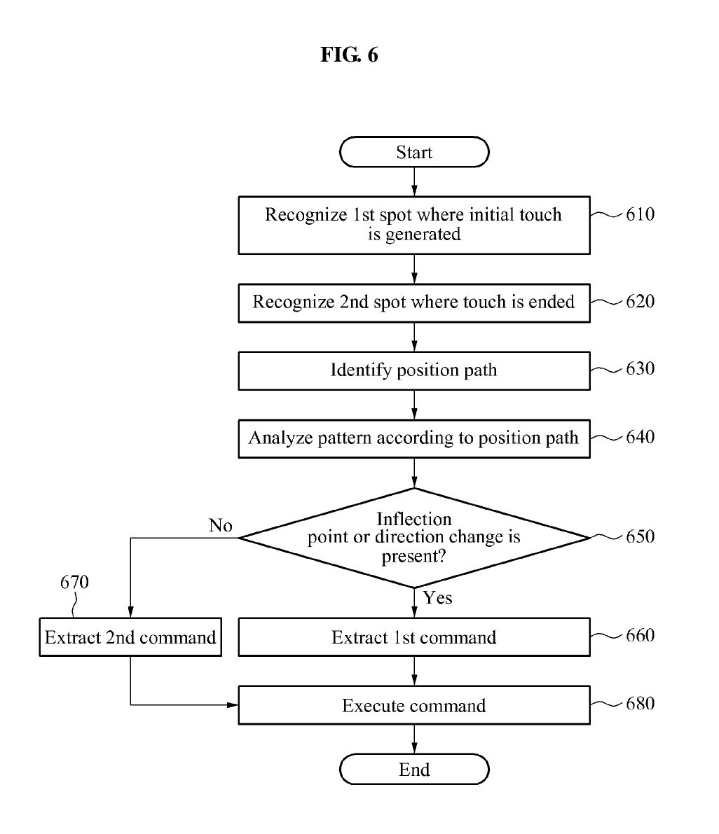

FIG. 6 is a flowchart illustrating a gesture input distinguishing method in a according to an embodiment of the present invention.

The gesture input distinguishing method according to the gesture input distinguishing apparatus may include counting a number of touches generated on a screen of a terminal that provides a GUI, converting the terminal into a gesture input mode when the number of touches is reduced to one, and executing a command corresponding to the reduction in the number of touches according to the conversion into the gesture input mode.

The converting of the terminal into the gesture input mode may include converting into the gesture input mode when the number of touches is reduced from at least two to one within a predetermined time.

The executing of the command corresponding to the reduced number of touches may include extracting a first gesture command from a DB by further considering the number of touches.

The method may further include executing the command corresponding to a touch and drag without converting the terminal into the gesture input mode, when the number of touches is maintained to n (n: natural number equal to or greater than two).

Hereinafter, a command execution method according to an embodiment will be described.

In operation 610, the command executor 200 may recognize a first spot in which a touch is generated on the screen. The first spot may have a position coordinate on the screen. The command executor 200 may measure a distance between a reference point on the screen and the first spot with respect to a vertical direction and a horizontal direction using the position coordinate.

In operation 610, the command executor 200 may recognize a plurality of first spots simultaneously. The number of the first spots may be determined by a number of available fingers of the user, a size of the screen, and the like. For example, the user may contact an index finger and a middle finger on the screen simultaneously, or may contact the index finger first and then contact the middle finger while maintaining the contact of the index finger. In this case, the command executor 200 may recognize two first spots at time points when touches of the index finger and the middle finger are simultaneously generated.

In operation 620, the command executor 200 may identify a path a position path indicating a position change from the first spot to a second spot in which the touch is ended. The first spot and the second spot may be in different positions. In operation 620, when the touch is generated in the first spot and ended in another spot, the command executor 200 may recognize the another spot as the second spot.

In operation 630, when an n-number of the first spots are recognized, where n is a natural number equal to or greater than two, the command executor 200 may identify an n-number of position paths from each of the n-number of first spots to the second spot.

In addition, when the length of the position path is considered in operation 630, the command executor 200 may set a reference value. When the length of the position path is smaller than the reference value, the command executor 200 may recognize the second spot to be same as the first spot, without considering the pattern. Conversely, when the length of the position path is not less than the reference value, the command executor 200 may execute a corresponding command considering the pattern.

In operation 640, the command executor 200 may analyze the pattern in consideration of the gesture of the user according to the pattern of the position path. In operation 640, the pattern of the position path may be analyzed into a straight line, a curve, a polygon, a circle, a number, and a character, and the like by considering at least one of a number of inflection points and a direction change of the position path.

In operation 650, the command executor 200 may determine whether the position path includes the inflection point or the direction change. When the position path includes the inflection point or the direction change as a result of the determination, the command executor 200 may extract a first gesture command in operation 660. In operation 650, the command executor 200 may set information on the pattern as conditions and detect whether same patterns are present in a DB. When the position path does not include the inflection point or the direction change as a result of the determination, the command executor 200 may extract a second gesture command in operation 670. The second gesture command may be a command for calling a selection function and a page turning function defined with respect to a single touch not the multi touch in the terminal.

In operation 680, the command executor 200 may execute the extracted command. In operation 680, the command executor 200 may call a function of controlling a program executed in the terminal according to the extracted command.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A gesture input distinguishing method comprising:
counting a number of touches generated on a screen of a terminal that provides a graphic user interface (GUI);
converting the terminal into a gesture input mode when the number of touches is reduced to one; and
executing a command corresponding to the reduced number of touches according to conversion into the gesture input mode.

2. The gesture input distinguishing method of claim 1, wherein the converting comprises:
converting into the gesture input mode when the number of touches is reduced from at least two to one within a predetermined time.

3. The gesture input distinguishing method of claim 1, wherein the executing of the command comprises:
recognizing a first spot in which the touch is generated;
identifying a position path from the first spot to a second spot in which the touch is ended;
analyzing a pattern of the position path; and
extracting a first gesture command corresponding to the pattern from a database (DB) and executing the first gesture command.

4. The gesture input distinguishing method of claim 3, wherein the executing of the command further comprising:
extracting the first gesture command from the DB by further considering the number of touches.

5. The gesture input distinguishing method of claim 3, wherein the analyzing of the pattern comprises:
analyzing the pattern by considering a gesture of a user according to a shape of the position path.

6. The gesture input distinguishing method of claim 3, wherein the analyzing of the pattern comprises:
analyzing the pattern by considering at least one of a number of inflection points and a direction change of the position path.

7. The gesture input distinguishing method of claim 6, wherein the analyzing of the pattern comprises:
executing a second gesture command set instead of the first gesture command when the inflection point and the direction change of the position path are absent.

8. The gesture input distinguishing method of claim 1, further comprising:
executing a command corresponding to a touch and drag without converting into the gesture input mode when the number of touches is maintained to n which is a natural number equal to or greater than two.

9. A gesture input distinguishing apparatus comprising:
a counter to count a number of touches generated on a screen of a terminal that provides a graphic user interface (GUI);
a mode converter to convert the terminal into a gesture input mode when the number of touches is reduced to one; and
a command executor to execute a command corresponding to the reduced number of touches according to conversion into the gesture input mode.

10. The gesture input distinguishing apparatus of claim 9, wherein the mode converter converts into the gesture input mode when the number of touches is reduced from at least two to one within a predetermined time.

11. The gesture input distinguishing apparatus of claim 9, wherein the command executor comprises:
a touch recognition unit to recognize a first spot in which the touch is generated;
a position path identifying unit to identify a position path from the first spot to a second spot in which the touch is ended;
a pattern analysis unit to analyze a pattern of the position path; and
a command execution unit to extract a first gesture command corresponding to the pattern from a database (DB) and execute the first gesture command.

12. The gesture input distinguishing apparatus of claim 11, wherein the command execution unit extracts the first gesture command from the DB by further considering the number of touches.

13. The gesture input distinguishing apparatus of claim 11, wherein the pattern analysis unit analyzes the pattern by considering a gesture of a user according to a shape of the position path.

14. The gesture input distinguishing apparatus of claim 11, wherein the pattern analysis unit analyzes the pattern by considering at least one of a number of inflection points and a direction change of the position path.

15. The gesture input distinguishing apparatus of claim 14, wherein the pattern analysis unit executes a second gesture command set instead of the first gesture command when the inflection point and the direction change of the position path are absent.

16. The gesture input distinguishing apparatus of claim 9, wherein the command execution unit executes a command corresponding to a touch and drag without converting into the gesture input mode when the number of touches is maintained to n which is a natural number equal to or greater than two.
